(19) United States
(12) Patent Application Publication
(10) Pub. No.: US 2026/0361412 A1
(43) Pub. Date: Nov. 12, 2026

(54) A HOLDER FOR AN OPTICAL TRANSMITTER TO PROVIDE AN OPTICAL BEAM CUT

(71) Applicant: SIGNIFY HOLDING B.V., EINDHOVEN (NL)

(72) Inventors: PHILIPPE HENRI ANDRÉ SIMON, VELDHOVEN (NL); MICHEL GERME, CORMELLES LE ROYAL (FR); VINCENT JOHANNES JACOBUS VAN MONTFORT, SITTARD (NL)

(21) Appl. No.: 19/109,202

(22) PCT Filed: Aug. 28, 2023
(86) PCT No.: PCT/EP2023/073469

§ 371 Date: Mar. 6, 2025

(30) Foreign Application Priority Data
Sep. 9, 2022 (EP) 22194731.0

(51) Int. Cl. H04B 10/50; H04B 10/40; H04B 15/00

(52) U.S. Cl. CPC H04B 10/501; H04B 10/40; H04B 15/00

(57) ABSTRACT

A holder comprising fastening means (110) configured to secure an optical transmitter for optical wireless communication; and a mechanical side shield (120) configured to shield a portion of a beam coverage zone of the optical transmitter with a straight cut.

### FIELD OF THE INVENTION

The invention relates to the field of optical wireless communication, such as Li-Fi communication. More particularly, various apparatus, systems, and methods are disclosed herein related to a holder to secure an optical transmitter and to provide an optical beam cut.

### BACKGROUND OF THE INVENTION

To enable more and more electronic devices like laptops, tablets, and smartphones to connect wirelessly to the Internet, wireless communication confronts unprecedented requirements on data rates and link qualities, and such requirements keep on growing year over year, considering the emerging digital revolution related to Internet-of-Things (IoT). Radio frequency technology like Wi-Fi has limited spectrum capacity to embrace this revolution.

In the meanwhile, optical wireless communication (OWC) is drawing more and more attention with its intrinsic security enhancement and capability to support higher data rates over the available bandwidth in visible light, Ultraviolet (UV), and Infrared (IR) spectra. Depending for example on the wavelengths used, such techniques may also be referred to as coded light, Light Fidelity (LiFi), visible light communication (VLC) or free-space optical communication (FSO). OWC or Li-Fi is directional and shielded by light blocking materials, which provides it with the potential to deploy a larger number of access points, as compared to Wi-Fi, in a dense area of users by spatially reusing the same bandwidth. These key advantages over wireless radio frequency communication make OWC or Li-Fi a promising secure solution to mitigate the pressure on the crowded radio spectrum for IoT applications and indoor wireless access. Other possible benefits of Li-Fi may include guaranteed bandwidth for a certain user, and the ability to function safely in areas otherwise susceptible to electromagnetic interference. Therefore, Li-Fi is a very promising technology to enable the next generation of immersive connectivity.

Due to line-of-sight requirement of optical wireless communication, the coverage area of a single optical cell is typically limited as compared to an RF based cell. Therefore, to provide sufficient coverage in a certain area, multiple optical cells are typically deployed. However, adjacent optical access points (APs) may interfere with each other if there is overlap between the wavelengths used by the two APs and/or if they transmit at the same time.

One way to enable the coexistence of two wireless optical networks in the same area without interference is to apply separate wavelengths per network. However, this solution presents few constraints and drawbacks:
limitation on the number of “off the shelf” wavelengths in the IR spectrum: only few LEDs can propose a reasonable high power to guarantee large coverage (i.e., 850 nm and 940 nm);
need for IR filters (low-pass, high-pass, or band-pass) to be placed in front of photoreceivers, to provide sufficient attenuation of unwanted wavelengths, and these IR filters are expensive;
Performance degradation versus temperature: LEDs typically present a peak wavelength shift versus temperature (i.e., 25 nm wavelength shift over Delta Temperature of 70 °C), which result in optical received power loss because of fixed cut-off frequency of IR filters.

Another way to enable the coexistence of two wireless optical networks in the same area without interference is to apply a channel access control method of Time Division Multiple Access (TDMA). Some baseband modules used for optical wireless communication have controllable timeslots. For example, by synchronizing baseband modules, it is possible to schedule the emission from multiple neighboring optical APs by allowing only one optical AP to emit at a time.

US10992380B2 relates to a system for transferring data between a rotating element and a fixed element by wireless optical communication.

JPH0897768A relates to an optical signal transmission section amplifying a received optical signal up to a prescribed level and emitting the signal, an optical signal reception section receiving/detecting the modulated optical signal are provided to an upper and a lower part of the optical repeater in which a received optical signal is amplified up to a prescribed level and emitted in space, and an optical diffusion plate for diffusing the emitted optical signal in space is provided at a proper position of the optical signal transmission section.

### SUMMARY OF THE INVENTION

To provide a good coverage in a certain area, multiple optical cells are typically deployed for accessing one or more external networks. As explained above, coexistence of the multiple optical APs in the same area may be solved by using wavelength-division multiplexing (WDM) or TDMA among the multiple optical APs. However, such solutions introduce additional system complexity.

In view of the above, the present disclosure is directed to apparatus and systems for providing a simple and efficient solution to control optical beam shape for interference avoidance in an optical wireless communication system. More particularly, the goal of this invention is achieved by an optical access point as claimed in claims 1 and 6 respectively.

In accordance with a first aspect of the invention an optical access point is provided. An optical access point comprising an optical transceiver configured to carry out optical wireless communication with an end device; and a holder comprises fastening means configured to secure the optical transmitter for optical wireless communication; and a mechanical side shield comprising a straight edge for shielding a portion of a beam coverage zone of the optical transmitter with a straight cut.

The mechanical side shield is made of a kind material that blocks light, such as wood, plastic, and metals that are opaque to light. Part of the optical beam emitted by the optical transmitter is blocked by the mechanical side shield with a straight-line cut.

The holder may be placed on a support surface, such as on a floor, a table, or another piece of furniture. Alternatively, the holder may be used to fix the optical transmitter on a mounting surface, such as for hanging the optical transmitter on the ceiling. Then, the holder may comprise a further fastening means for that function.

The holder may also be used to secure an optical transceiver to create an optical beam cut to avoid both uplink and downlink interferences between adjacent optical communication zones.

The mechanical side shield comprising at least one straight edge for shielding a portion of a beam coverage zone of the optical transmitter with a straight cut.

Preferably, the mechanical side shield is in a rectangular shape.

Considering a typical cone beam, in order to provide a straight optical cut on the beam footprint, it is preferable to make the mechanical side shield rectangular in shape.

Alternative shape may also be used if the optical cut follows a straight line. For example, one or more sides of the mechanical side shield may also be curved.

Beneficially, the mechanical side shield has an adjustable size and/or orientation.

Considering that different light sources and different lens may be used in the optical transmitter, it is desired that the holder can provide more flexibility.

In one option, the mechanical side shield may have an adjustable size, such as the mechanical side shield further comprising a folding or sliding part.

In another option, the mechanical side shield may have an adjustable orientation. And then, the portion of the blocked beam area as compared to a maximum beam area supported by the optical transmitter may be easily controlled by adjusting the orientation of the mechanical side shield.

The two options may be used independently or combinedly to cater for different application scenarios, such as different layouts of the deployment area, or different optical transmitters comprising different light sources and/or lens.

In one setup, the fastening means is configured to secure the optical transmitter in a tilted position regarding a surface vertical to a mounting or support surface of the holder.

The tilted position may be determined according to a coverage area to be achieved, the beam angle of the optical transmitter, and the distance from the optical transmitter to target end devices.

As one example, when the optical transceiver has a beam angle of +/−35 degrees, the tilt angle of the transceiver is preferably 30 degrees from the vertical to enable a vertical communication as the transceiver.

The tilt angle may be adjustable, such that the tilted position can be reconfigured according to the actual beam angle to be used and an actual deployment requirement.

In one option, the tilt angle of the fastening means may be controlled independently to the orientation of the mechanical side shield. In another option, the mechanical side shield may be coupled to the fastening means, and then the tilt angle of the fastening means will also determine the orientation of the mechanical side shield.

Advantageously, the fastening means is configured to secure the optical transmitter in a detachable manner.

The holder may be permanently fixed to a certain mounting surface or support surface. It is then convenient that the optical transmitter is placed in the fastening means in a detachable manner.

In accordance with a second aspect of the invention an optical access point is provided. An optical access point comprises more than one optical transceiver configured to carry out optical wireless communication with one or more end devices; and a holder comprises fastening means configured to secure the more than one optical transmitter for optical wireless communication; and more than one mechanical side shield, with each comprising a straight edge for shielding a portion of a beam coverage zone of an individual optical transmitter, out of the more than one optical transmitter, with a straight cut.

To provide as complete coverage of an area as possible, it is beneficial that two or more adjacent optical cells can be close to each other but with reduced interference to each other. Therefore, the holder according to the second aspect can be used to satisfy this requirement, such that two or more adjacent optical transmitters are secured to the same holder, and the beam area of an individual optical transmitter is controlled by a corresponding mechanical side shield.

Depending on the target coverage area and the number of optical transmitters or transceivers to be deployed, the holder may be constructed as a double holder, a triple holder, or multiple holder. The use of which type of holders or the combination of different types of holders will depend on the layout of a target coverage area.

The holder may also be used to secure more than one optical transceiver to create optical beam cuts for the more than one optical transceiver to avoid both uplink and downlink interferences between any two adjacent optical communication zones.

Preferably, each mechanical side shield is in a rectangular shape.

Beneficially, each mechanical side shield has an adjustable size and/or orientation.

In one setup, the fastening means is configured to secure each optical transmitter in a tilted position regarding a surface vertical to a mounting or support surface of the holder.

Advantageously, the fastening means is configured to secure the more than one optical transmitter to avoid overlap between beam coverage zones of any two optical transmitters out of the more than one optical transmitter.

Preferably, the fastening means is further configured to secure the more than one optical transmitter to generate a full coverage of a targeted communication area.

By controlling one or more out of the tilt angles of the optical transmitters, the size and/or orientations of the more than one mechanical side shield, the fastening means may be configured to secure the more than one optical transmitter to avoid overlap between beam coverage zones of any two optical transmitters and to provide a complete optical wireless communication coverage of a target area.

Advantageously, the fastening means is configured to secure each optical transmitter in a detachable manner.

The holder may be permanently fixed to a certain mounting surface or support surface. It is then convenient that the optical transmitter is placed in the fastening means in a detachable manner.

In accordance with a third aspect of the invention an optical access point is provided. An optical access point comprises an optical transceiver configured to carry out optical wireless communication with an end device; and a holder according to the present invention configured to secure the optical transceiver and shield a portion of a beam coverage zone of the optical transceiver.

In the following, the term “access point” of a Li-Fi system is used to designate a logical access device that can be connected to one or more physical access devices (e.g., optical transceivers). Such a physical access device may typically, but not necessary, be located at a luminaire and the logical access point may be connected to one or more physical access devices each located at one or more luminaires. An access point in turn may serve one or more network devices or end devices associated to it to thereby.

An optical wireless communication (OWC) access point, or a Li-Fi access point, provides electronic devices or end devices within the corresponding optical cell access to an external network via an optical wireless link. The OWC access point can also support bi-directional optical links with more than one end device at the same time.

The optical wireless communication may be carried out in visible light, Ultraviolet (UV), and Infrared (IR) spectra. Thus, the optical wireless communication may also be called a Li-Fi communication or a Visible Light Communication (VLC). The optical transceiver may comprise at least a light source for optical data transmission and a light detector for optical data reception. The light source or light emitter may be one of a light-emitting diode (LED), a laser diode, a vertical-cavity surface-emitting laser (VCSEL), or an Edge Emitting Laser Diode (EELD). Preferably, the light source comprises at least one of a LED and a VCSEL. The light detector, also called photo detector or photo sensor, is a photodiode, which may be a PIN diode, an Avalanche Photo Diode (APD), or a photomultiplier.

In accordance with a further aspect of the invention an optical access point is provided. An optical access point comprises more than one optical transceiver configured to carry out optical wireless communication with one or more end devices; and a holder according to the present invention configured to secure the more than one optical transceiver and shield a portion of each beam coverage zone of an individual optical transceiver out of the more than one optical transceiver.

The optical AP may also comprise more than one optical transceiver with the aid of a double, triple, or multiple holder according to the present invention.

Advantageously, the optical access point further comprises more than one communication interfaces connected to more than one networks; wherein at least two out of the more than one optical transceiver are configured to provide connections to different networks out of the more than one networks.

In certain application scenarios, end devices in the same area may need to access different external networks, which may have different domains, security levels, and/or priority levels. Example use cases include scenarios where accessibility needs to be provided for both public and private networks in the same area, such as hotels, public sectors, and enterprises. Other applications include military and defense, such as providing accessibility to multiple networks with different security levels. To provide connectivity to these multiple external networks in the same area, one or more out of the more than one optical transceiver may be connected to different external networks.

The different external networks may be either wired networks or wireless networks. It may also be that one of the external networks is a wired network, and another one of the external networks is a wireless network. A wired network may be an Ethernet, a power line communication (PLC) network, or a plastic optical fiber (POF) network. The wireless network may be based on a millimeter wave communication system, or a 5G cellular network.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 illustrates an example of a holder;

FIG. 2 shows a picture of the example of the holder;

FIG. 3 illustrates an example of a holder;

FIG. 4 shows a picture of the example of the holder;

FIG. 5 shows a block diagram of an optical access point;

FIG. 6 shows a block diagram of an optical access point;

FIG. 7 shows a block diagram of an optical access point;

FIG. 8 illustrates coverage area of an optical transceiver on surfaces with different distances from the optical transceiver;

FIG. 9 illustrates an interference scenario between two adjacent optical cells in a conventional system;

FIG. 10 illustrates deployment of optical cells in a conventional system to provide full coverage;

FIG. 11 demonstrates an example installation of the optical transceiver on the holder;

FIG. 12 demonstrates an example of resulted coverage area of two adjacent optical cells;

FIG. 13 demonstrates measurement results of achievable data rates with different distances to the access points and at different locations in the coverage area of two adjacent optical cells; and

FIG. 14 illustrates an example of deploying optical cells in a rectangular area.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

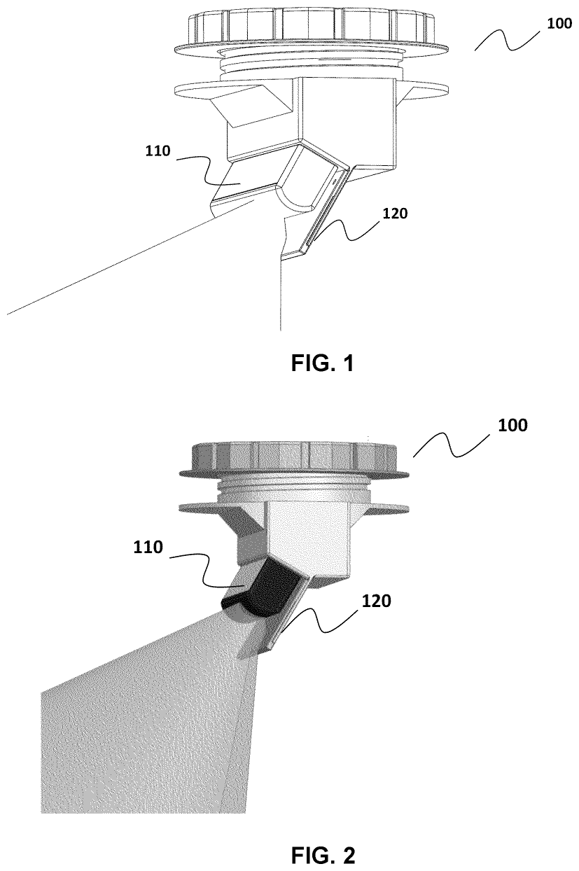

FIG. 1 illustrates an example of a holder 100. The holder 100 comprises fastening means 110 configured to secure an optical transmitter for optical wireless communication; and a mechanical side shield 120 configured to shield a portion of a beam coverage zone of the optical transmitter with a straight cut.

In this example shown in FIG. 1, the holder 100 comprise a further fastening means used to fix the holder to a mounting surface, such as for hanging the holder and the optical transceiver on the ceiling. In an alternative scenario, the holder may not need the further fastening means when it is placed on a support surface, such as on a table.

The holder 100 may also be used to secure an optical transceiver to create an optical beam cut to avoid both uplink and downlink interferences between adjacent optical communication zones.

FIG. 2 shows a picture of the same holder 100 in FIG. 1. The beam shape of the optical transmitter is indicated by the shadow. It can be seen that the mechanical side shield 120 provides a straight cut on one side of the beam.

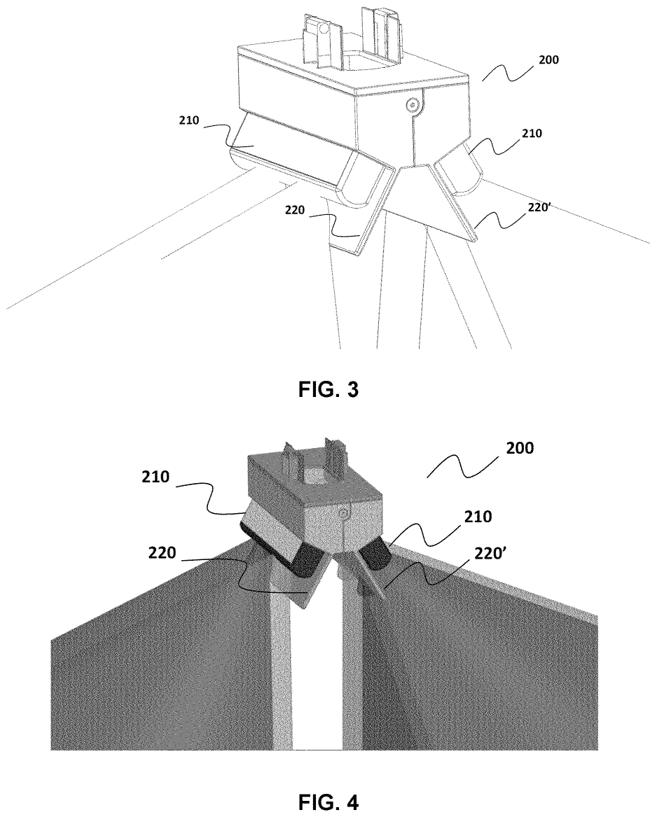

FIG. 3 illustrates an example of a holder 200. The holder 200 comprises fastening means 210 configured to secure more than one optical transmitter for optical wireless communication; and more than one mechanical side shield 220, 220′, with each configured to shield a portion of a beam coverage zone of an individual optical transmitter, out of the more than one optical transmitter, with a straight cut.

The holder 200 may also be used to secure more than one optical transceiver to create optical beam cuts for the more than one optical transceiver to avoid both uplink and downlink interferences between any two adjacent optical communication zones.

This example shows a double holder 200. As aforementioned, it may also be a triple or multiple holder 200 to secure three or more optical transceivers. The use of which type of holders or the combination of different types of holders will depend on the layout of the target coverage area.

In the example shown in FIG. 3, the double holder 200 comprise a further fastening means used to fix the holder to a mounting surface, such as for hanging the holder 200 and the optical transceivers on the ceiling. In an alternative scenario, the holder 200 may not have the further fastening means when it is placed on a support surface, such as on a table.

FIG. 4 shows a picture of the same holder 200 in FIG. 3. The beam shape of the optical transmitter is indicated by the shadow. It can be seen that the mechanical side shields 220, 220′ provide straight cut on the adjacent edges of the beams from two optical transceivers.

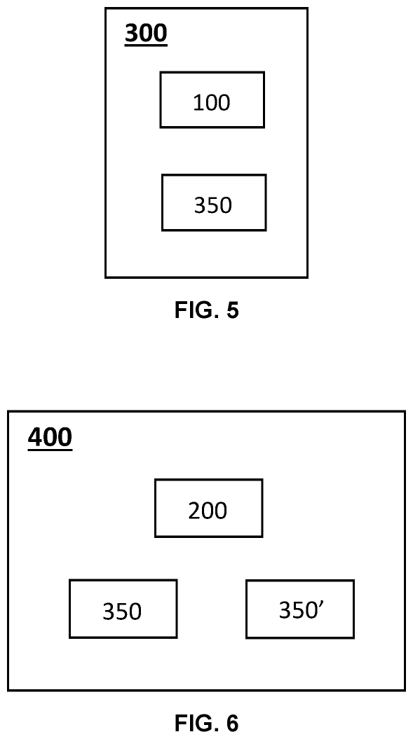

FIG. 5 shows a block diagram of an optical access point 300. The optical access point 300 comprises an optical transceiver 350 configured to carry out optical wireless communication with an end device; and a holder 100 according to the present invention configured to secure the optical transceiver 350 and shield a portion of a beam coverage zone of the optical transceiver 350.

The optical transceiver 350 may comprise at least a light source for optical data transmission and a light detector for optical data reception. The light source or light emitter may be one of a light-emitting diode (LED), a laser diode, a vertical-cavity surface-emitting laser (VCSEL), or an Edge Emitting Laser Diode (EELD). Preferably, the light source comprises at least one of a LED and a VCSEL. The light detector, also called photo detector or photo sensor, is a photodiode, which may be a PIN diode, an Avalanche Photo Diode (APD), or a photomultiplier.

FIG. 6 shows a block diagram of an optical access point 400. The optical access point 400 comprises more than one optical transceiver 350, 350′ and a holder 200 according to the present invention. The optical transceivers 350, 350′ are configured to carry out optical wireless communication with one or more end devices. The holder 200 is configured to secure the more than one optical transceiver 350, 350′ and shield a portion of each beam coverage zone of an individual optical transceiver out of the more than one optical transceiver 350, 350′.

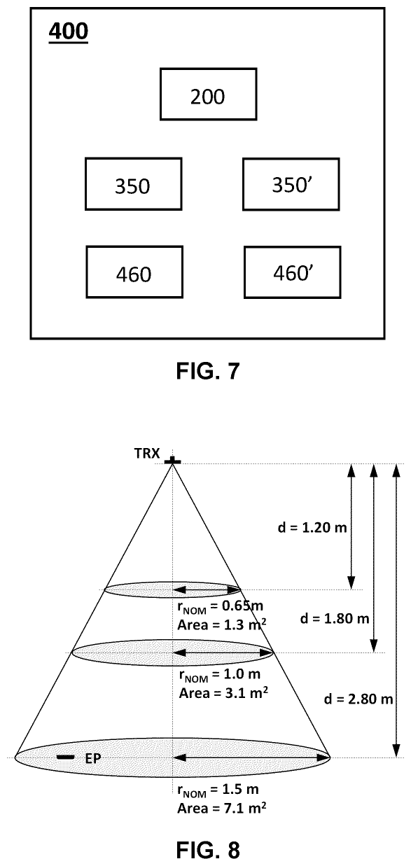

FIG. 7 shows a block diagram of an optical access point 400 according to a further example. The optical access point 400 further comprises more than one communication interfaces 460, 460′ connected to more than one networks; and at least two out of the more than one optical transceiver 350, 350′ are configured to provide connections to different networks out of the more than one networks.

In certain application scenarios, end devices in the same area may need to access different external networks, which may have different domains, security levels, and/or priority levels. Example use cases include scenarios where accessibility needs to be provided for both public and private networks in the same area, such as hotels, public sectors, and enterprises. Other applications include military and defense, such as providing accessibility to multiple networks with different security levels.

The more than one external networks may be either wired networks or wireless networks. It may also be that one of the external networks is a wired network, and another one of the external networks is a wireless network. A wired network may be an Ethernet, a Power-Line Communication (PLC) network, or a Plastic Optical Fiber (POF) network. The wireless network may be based on a millimeter wave communication system, or a 5G cellular network.

FIG. 8 illustrates an example of coverage area of an optical transceiver on surfaces with different distances from the optical transceiver. In this example, it assumes a circular beam, and the coverage area of the optical cell has a nominal radius that increases with the distance from the optical transceiver. Depending on the beam shape used by the system, the coverage area may also have other shapes. Of course, the data rates to be provided to an end device located on a certain surface will decrease accordingly with the increased distance from the optical transceiver. In that sense, deploying the AP further away from the target end device allows for larger coverage area but lower data rates can be supported.

In an example of an optical wireless communication (OWC) system, ceiling mounted OWC access points (APs) may be integrated with luminaires with general lighting functions. This may be a good placement for an AP function as luminaries are also preferably placed to illuminate a space homogeneously and completely. To guarantee the coverage, the beams from adjacent APs will have overlap regions, and end devices (ED) located in such overlapping regions may experience interferences when the adjacent APs transmit simultaneously. Similarly, those ED may also produce overlapping beams at an AP side and result in interferences to each other in the uplink.

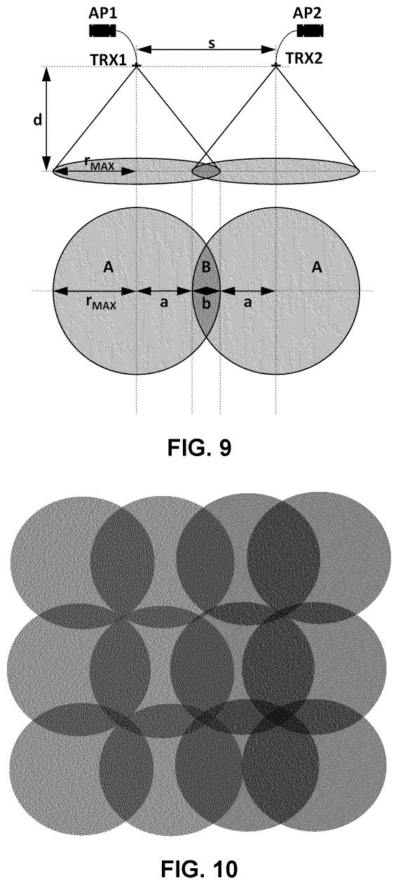

FIG. 9 illustrates the interference scenario between two adjacent optical cells in a conventional system. The optical access points AP1 and AP2 comprise optical transceivers TRX1 and TRX2 respectively, and the separation distance between the two transceivers is indicated by s in the figure. The distance between the optical transceiver and the targeted end device is d. The area A represents coverage area without overlapping, and the area B represents the overlapping area, or the interference zone. The radius of a conventional optical cell is indicated by r_{MAX}. The width of the interference area is indicated by b, and accordingly the radius, towards an adjacent cell, without interference is a, which is equal to r_{MAX}−b.

FIG. 10 illustrates deployment of optical cells in a conventional system to provide full coverage. Each circle indicates an optical cell. And to provide a full coverage of a rectangular shaped area, 12 optical cells are deployed. When an end device is located in an overlap area between any two or more adjacent optical cells, it will experience interference from the two or more adjacent APs. Furthermore, it can be seen that there is always a trade-off on designing the deployment between coverage and interference in such a conventional system. To achieve a full coverage, overlap area or interference area is inevitable.

Interference avoidance among the multiple APs may be handled by using wavelength multiplexing or Time-division multiple access (TDMA). However, these conventional interference avoidance techniques have certain limitations and disadvantages, such that they add extra complexity and overhead to the system.

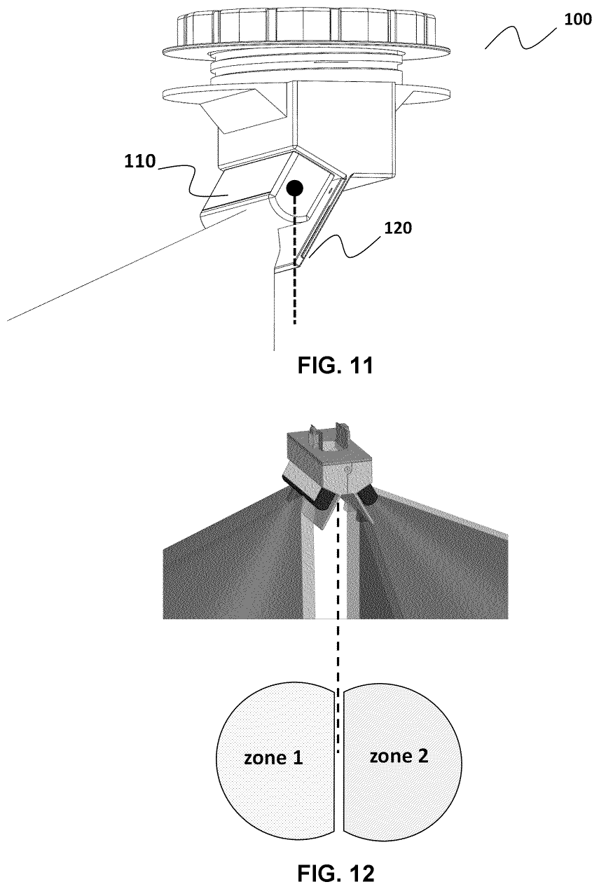

FIG. 11 demonstrates an example installation of the optical transceiver 350 on the holder 100. The black dot exemplarily indicates a preferred position to place a light source and a light sensor of the optical transceiver 350. The dash line shows that the mechanical side shield 120 provides a vertical optical cut on the outgoing and incoming beams to the optical transceiver 350.

FIG. 12 demonstrates an example of resulted coverage area of two adjacent optical cells according to the present invention. A juxtaposition of two adjacent coverage zones, zone 1 and zone 2 is achieved by using a double holder 200 with two optical transceivers. When the two optical transceivers are connected with different external networks via separate communication interfaces 460, zone 1 and zone 2 will also provide end devices located in neighboring area with different optical networks, such as two different LiFi networks.

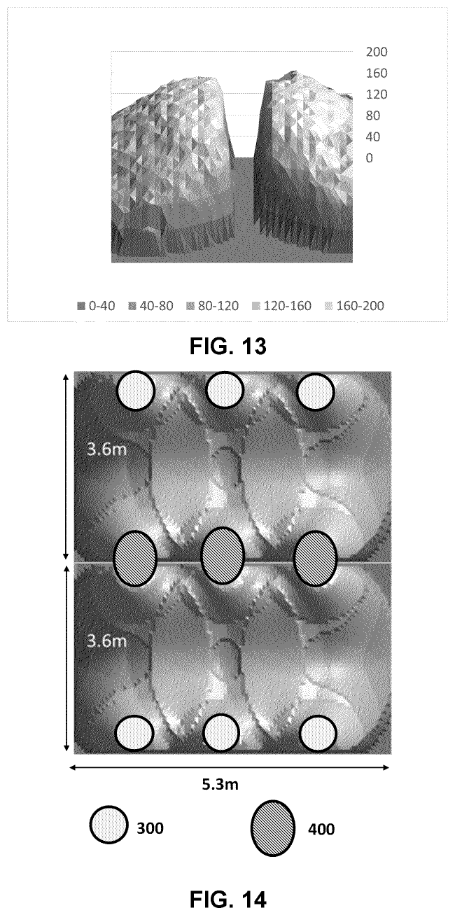

FIG. 13 demonstrates exemplarily measurement results of achievable data rates with different distances to the access points and at different locations in the coverage area of two adjacent optical cells, such as in zone 1 and zone 2 as shown in FIG. 12. In this example, the maximum data rate to be supported is 200 Mbps. As shown in the figure, the data rates to be provided to an end device located on a certain surface will decrease with the increased distance from the optical transceiver. In that sense, deploying the AP further away from the target end device allows for larger coverage area but lower data rates can be supported. With a double holder, two optical cuts are provided on the adjacent edges of the two optical cell. It can be seen that the advantage of the disclosed solution is that the optical cut provided by the mechanical side shield 120 is independent from the distance between the EP and the transceiver, especially when the optical cut is vertical.

FIG. 14 illustrates an example of deploying optical cells in a rectangular area. Depending on the shape and/or size of the entire surface to covered by optical wireless communication, different combinations of single-transceiver holders 100, double-transceiver holders or multiple-transceiver holders 200 can be used. Further adjustments can be made by changing the sizes and/or orientations of mechanical side shields of one or more of the holders, or by adjusting fastening means of one or more of the holders to change the tilted position of a corresponding optical transceiver.

In this example with a rectangular coverage area, three APs 400 each with a double-transceiver holder 200 are deployed in the middle of the zone, while three APs 300 each with a single-transceiver holder 100 are respectively deployed on the top and bottom edges of the zone.

In this example the APs 300, 400 are placed in luminaires on the ceiling, horizontally in the picture above a pitch of 1.8 m and vertically a pitch of 3.6 m. When the shape and/or size of the room doesn't match a standard or default beam shape of an optical transceiver, further aforementioned adjustments can be made, such as adding more transceivers in an AP, changing the shape of the beam, adjusting the tilting position of the transceiver, changing the sizes and/or orientations of mechanical side shields, etc.

1. An optical access point comprising:
an optical transceiver configured to carry out optical wireless communication with an end device; and
a holder comprising:
fastening means configured to secure the optical transceiver for optical wireless communication; and
a mechanical side shield comprising a straight edge for shielding a portion of a beam coverage zone of the optical transceiver with a straight cut.

2. The optical access point of claim 1, wherein the mechanical side shield is in a rectangular shape.

3. The optical access point of claim 1, wherein the mechanical side shield has an adjustable size and/or orientation.

4. The optical access point of claim 1, wherein the fastening means is configured to secure the optical transceiver in a tilted position regarding a surface vertical to a mounting or support surface of the holder.

5. The optical access point of claim 1, wherein the fastening means is configured to secure the optical transceiver in a detachable manner.

6. An optical access point comprising:
more than one optical transceiver configured to carry out optical wireless communication with one or more end devices; and
a holder comprising:
fastening means configured to secure the more than one optical transceiver for optical wireless communication; and
more than one mechanical side shield, with each comprising a straight edge for shielding a portion of a beam coverage zone of an individual optical transceiver, out of the more than one optical transmitter, with a straight cut.

7. The optical access point of claim 6, wherein each mechanical side shield is in a rectangular shape.

8. The optical access point of claim 6, wherein each mechanical side shield has an adjustable size and/or orientation.

9. The optical access point of claim 6, wherein the fastening means is configured to secure each optical transceiver in a tilted position regarding a surface vertical to a mounting or support surface of the holder.

10. The optical access point of claim 6, wherein the fastening means is configured to secure the more than one optical transceiver to avoid overlap between beam coverage zones of any two optical transceivers out of the more than one optical transceiver.

11. The optical access point of claim 10, wherein the fastening means is further configured to secure the more than one optical transceiver to generate a full coverage of a targeted communication area.

12. The optical access point of claim 6, wherein the fastening means is configured to secure each optical transceiver in a detachable manner.

13. The optical access point of claim 6 further comprising more than one communication interfaces connected to more than one networks; wherein at least two out of the more than one optical transceiver are configured to provide connections to different networks out of the more than one networks.
